(19) United States
(12) Patent Application Publication
(10) Pub. No.: US 2015/0009466 A1
(43) Pub. Date: Jan. 8, 2015

(54) LIQUID CRYSTAL PANEL AND DISPLAY DEVICE

(71) Applicant: BOE TECHNOLOGY GROUP CO., LTD., Beijing (CN)

(72) Inventors: Guangkui Qin, Beijing (CN); Teruaki Suzuki, Beijing (CN)

(21) Appl. No.: 14/351,706

(22) PCT Filed: Jun. 28, 2013
(86) PCT No.: PCT/CN2013/078461

§ 371 Date: Apr. 14, 2014

(30) Foreign Application Priority Data
Apr. 28, 2013 (CN) 201310155715.X

(51) Int. Cl. G02F 1/1343; G02F 1/137

(52) U.S. Cl. CPC G02F 1/134363; G02F 1/137; G02F 2001/13706
USPC 349/139

(57) ABSTRACT

A liquid crystal panel and a display device are provided. The liquid crystal panel comprises a liquid crystal layer and a pixel region. The pixel region comprises a plurality of pixel units. Each of the pixel units comprises a first subsidiary region (310) and a second subsidiary region (320). In an initial state, a major axis direction of liquid crystal molecules in the liquid crystal layer corresponding to the first subsidiary region (310) forms an angle of 90 degrees with respect to a major axis direction of the liquid crystal molecules in the liquid crystal layer corresponding to the second subsidiary region (320). The first subsidiary region (310) comprises two subsidiary sub-regions, and the second subsidiary region (320) comprises one or two subsidiary sub-regions. At least two electrodes for applying an In-plane electric field to the liquid crystal layer are disposed in the subsidiary sub-regions of the first and second subsidiary regions (310) and (320), respectively. At least one of the two electrodes comprises a strip electrode. The strip electrodes of the two subsidiary sub-region of the first subsidiary region (310) form an angle larger than 0 degree and less than 180 degrees with respect to each other. The liquid crystal panel and the display device alleviate the problems of poor viewing angle characteristics and severe color shift at different viewing angles of the conventional liquid crystal panel.

### TECHNICAL FIELD

Embodiments of the present invention relate to the liquid crystal display technical field, and more particularly, to a liquid crystal panel and a display device.

### BACKGROUND

Existing wide viewing angle liquid crystal panels mainly include In-Plane Switching (IPS) panels and Advanced Super Dimension Switch (AD-SDS or ADS) panels. The main characteristics of the IPS panel include that the pixel electrodes and common electrodes of the IPS panel are disposed on a same surface, unlike other liquid crystal panels in which the electrodes are respectively disposed on an upper level and a lower level respectively and in a three-dimensional manner. The ADS technique is a wide viewing angle technique in the liquid crystal industry for achieving the applications of desktop monitors and liquid crystal TV with large-size and high-definition, which is commonly known as a hard screen technology. An ADS panel forms multidimensional electric fields through the electric filed generated by edge of slit electrodes in a same plane and the electric field generated between a slit electrode layer and a plate-shaped electrode layer, enables liquid crystal molecules at all orientations between slit electrodes and right above the electrodes in the liquid crystal cell to rotate, thus improve the efficiency of the liquid crystals and increase light transmittance.

FIG. 1 is a structural schematic view of a pixel according to a first kind of conventional liquid crystal panel. The liquid crystal panel is an IPS panel. The straight arrows denote the directions of the electric fields generated by the pixel electrodes 110, and the curved arrows denote the rotation directions of the liquid crystal molecules 120 under the electric fields. Common electrodes 130 are disposed between adjacent pixel electrodes 110. FIG. 2 is a graph illustrating transmittance vs. voltage of the first conventional liquid crystal panel, in which the range of variation of the transmittance of each curve is from full black to full white at a corresponding viewing angle. Polar angle of all curves is 60 degrees, the azimuth angle (Phi in the figure) changes between 0 degree and 150 degrees, and the increment step is 30 degrees. That is to say, the curves illustrating transmittance versus voltage (in volts) are obtained by stimulation when the transmittance of the liquid crystal panel changes from full black to full white under the conditions that the polar angle is 60 degrees and the azimuth angles (Phi in the figure) are 0 degrees, 30 degrees, 60 degrees, 90 degrees, 120 degrees and 150 degrees, respectively. It can be seen from FIG. 2 that the six curves of transmission versus voltage corresponding to different viewing angles (different azimuth angles when the polar angles are the same) show severe decentrality and relatively greater difference with poor coincidence, which leads to different gray scale curves at different viewing angles. In this case, even at a same voltage, the transmittance is different, and thus the gray scales are different, so that the viewing angle characteristics deteriorate. On the other hand, since the transmittance at different viewing angles is different, anisotropy states of liquid crystal molecules corresponding to different viewing angles are different also, so the difference in color of each gray scale voltage at different viewing angles is great, i.e., the so-called color shift occurs.

### SUMMARY

An embodiment of the present invention provides a liquid crystal panel, comprising a liquid crystal layer and a pixel region, the pixel region comprises a plurality of pixel units, each of the pixel units comprises a first subsidiary region and a second subsidiary region. In an initial state, a major axis direction of liquid crystal molecules in the liquid crystal layer corresponding to the first subsidiary region forms an angle of 90 degrees with respect to a major axis direction of the liquid crystal molecules in the liquid crystal layer corresponding to the second subsidiary region. The first subsidiary region comprises at least two subsidiary sub-regions, and the second subsidiary region comprises at least one subsidiary sub-region. At least two electrodes for applying In-plane electric field to the liquid crystal layer are disposed in the subsidiary sub-regions of the first and second subsidiary regions, respectively. At least one of the two electrodes comprises a strip electrode. The two subsidiary sub-regions included in the first subsidiary region are a first subsidiary sub-region and a second subsidiary sub-region. The strip electrode of the first subsidiary sub-region forms an angle larger than 0 degree and less than 180 degrees with respect to the strip electrode of the second subsidiary sub-region.

Further, in the initial state, a major axis direction of liquid crystal molecules in the liquid crystal layer corresponding to the first subsidiary region forms a first angle with respect to the strip electrode of the first subsidiary sub-region and forms a second angle with respect to the strip electrode of the second subsidiary sub-region. The first angle is equal to the second angle.

Further, the second subsidiary region comprises a third subsidiary sub-region and a fourth subsidiary sub-region. The strip electrode of the third subsidiary region forms an angle larger than 0 degree and less than 180 degrees with respect to the strip electrode of the fourth subsidiary region.

Further, in the initial state, a major axis direction of liquid crystal molecules in the liquid crystal layer corresponding to the second subsidiary region forms a third angle with respect to the strip electrode of the third subsidiary sub-region and forms a fourth angle with respect to the strip electrode of the fourth subsidiary sub-region. The third angle is equal to the fourth angle.

Further, in the initial state, a major axis direction of liquid crystal molecules in the liquid crystal layer corresponding to the first subsidiary region forms a first angle with respect to the strip electrode of the first subsidiary sub-region and forms a second angle with respect to the strip electrode of the second subsidiary sub-region. The first, second, third and fourth angles are equal to each other.

Further, the first, second, third and fourth subsidiary sub-regions have equal areas.

Further, where the liquid crystal molecules are positive liquid crystal molecules, in the initial state, angles between the major axis direction of the liquid crystal molecules of the liquid crystal layer corresponding to the first subsidiary region and the strip electrodes of the subsidiary sub-regions of the first subsidiary region are in the range between 3 and 30 degrees, and in the initial state, angles between the major axis direction of the liquid crystal molecules of the liquid crystal layer corresponding to the second subsidiary region and the strip electrodes of the subsidiary sub-regions of the second subsidiary region are in the range between 3 and 30 degrees. Where the liquid crystal molecules are negative liquid crystal molecules, in the initial state, the angles between the minor axis direction of the liquid crystal molecules of the liquid crystal layer corresponding to the first subsidiary region and the strip electrodes of the subsidiary sub-regions of the first subsidiary region is in the range between 3 and 35 degrees, and in the initial state, the angles between the minor axis direction of the liquid crystal molecules of the liquid crystal layer corresponding to the second subsidiary region and the strip electrodes of the subsidiary sub-regions of the second subsidiary region are in the range between 3 and 35 degrees.

Further, one of the two electrodes in the sub-regions of the first subsidiary region and the second subsidiary region of the liquid crystal panel comprises a strip electrode, and the other of the two electrodes is plate-shaped electrode. Where the liquid crystal molecules are positive liquid crystal molecules, in an initial state, angles between the major axis direction of the liquid crystal molecules of the liquid crystal layer corresponding to the first subsidiary region and the strip electrodes of the subsidiary sub-regions of the first subsidiary region are in the range between 5 and 14 degrees, and in the initial state, the angles between the major axis direction of the liquid crystal molecules of the liquid crystal layer corresponding to the second subsidiary region and the strip electrodes of the subsidiary sub-regions of the second subsidiary region are in the range between 5 and 14 degrees. Where the liquid crystal molecules are negative liquid crystal molecules, in the initial state, the angles between the minor axis direction of the liquid crystal molecules of the liquid crystal layer corresponding to the first subsidiary region and the strip electrodes of the subsidiary sub-regions of the first subsidiary region are in the range between 5 and 14 degrees, and in the initial state, the angles between the minor axis direction of the liquid crystal molecules of the liquid crystal layer corresponding to the second subsidiary region and the strip electrodes of the subsidiary sub-regions of the second subsidiary region is in the range between 5 and 14 degrees.

Further, both of the two electrodes in the sub-regions of the first subsidiary region and the second subsidiary region of the liquid crystal panel comprise a strip electrode, and the two electrodes are alternatively disposed. Where the liquid crystal molecules are positive liquid crystal molecules, in the initial state, the angles between the major axis direction of the liquid crystal molecules of the liquid crystal layer corresponding to the first subsidiary region and the strip electrodes of the subsidiary sub-regions of the first subsidiary region are in the range between 11 and 20 degrees, and in the initial state, the angles between the major axis direction of the liquid crystal molecules of the liquid crystal layer corresponding to the second subsidiary region and the strip electrodes of the subsidiary sub-regions of the second subsidiary region are in the range between 11 and 20 degrees. Where the liquid crystal molecules are negative liquid crystal molecules, in the initial state, the angles between the minor axis direction of the liquid crystal molecules of the liquid crystal layer corresponding to the first subsidiary region and the strip electrodes of the subsidiary sub-regions of the first subsidiary region are in the range between 11 and 20 degrees, and in the initial state, the angles between the minor axis direction of the liquid crystal molecules of the liquid crystal layer corresponding to the second subsidiary region and the strip electrodes of the subsidiary sub-regions of the second subsidiary region are in the range between 11 and 20 degrees.

Further, an embodiment of the present invention provides a display device comprising any of the above mentioned liquid crystal panels.

### BRIEF DESCRIPTION OF THE DRAWINGS

FIG. 1 is a structural schematic view of electrodes in pixel unit according to a first conventional liquid crystal panel;

FIG. 2 is a graph illustrating the curves of transmittance vs. voltage of the first conventional liquid crystal panel;

FIG. 3a is a structural schematic view of the electrodes in a pixel unit of a liquid crystal panel according to embodiment 1 of the present invention;

FIG. 3b is a cross-sectional view taken along line A-A of FIG. 3a;

FIG. 3c is a graph illustrating the curves of transmittance vs. voltage of a liquid crystal panel according to embodiment 1 of the present invention;

FIG. 4a is a structural schematic view of the pixel unit of a liquid crystal panel according to embodiment 2 of the present invention;

FIG. 4b is a cross-sectional view taken along line B-B of FIG. 4a; and

FIG. 4c is a structural schematic view of a modified pixel unit of the liquid crystal panel according to embodiment 2 of the present invention.

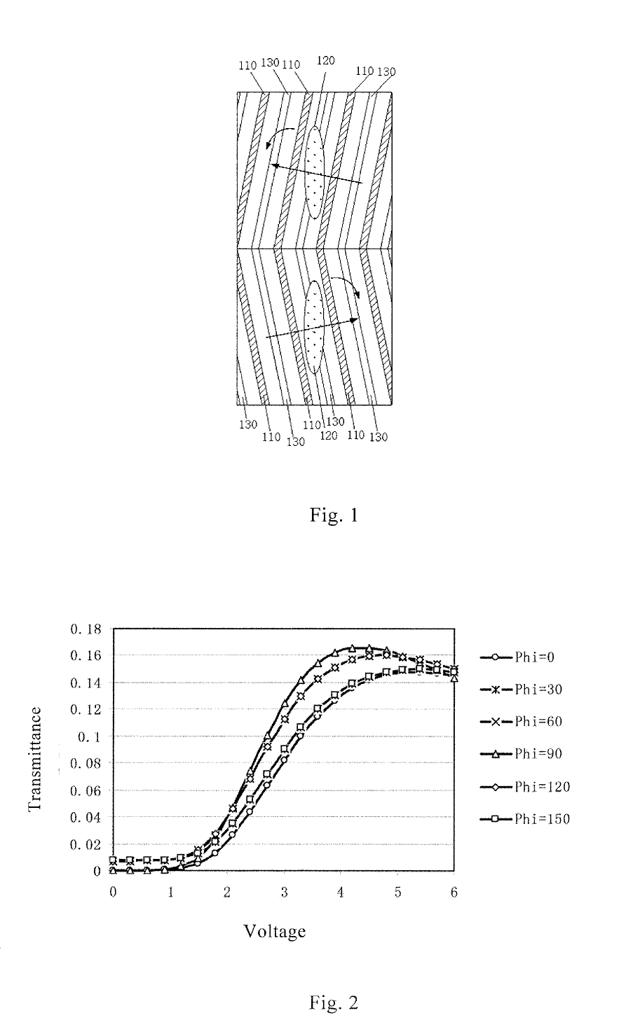

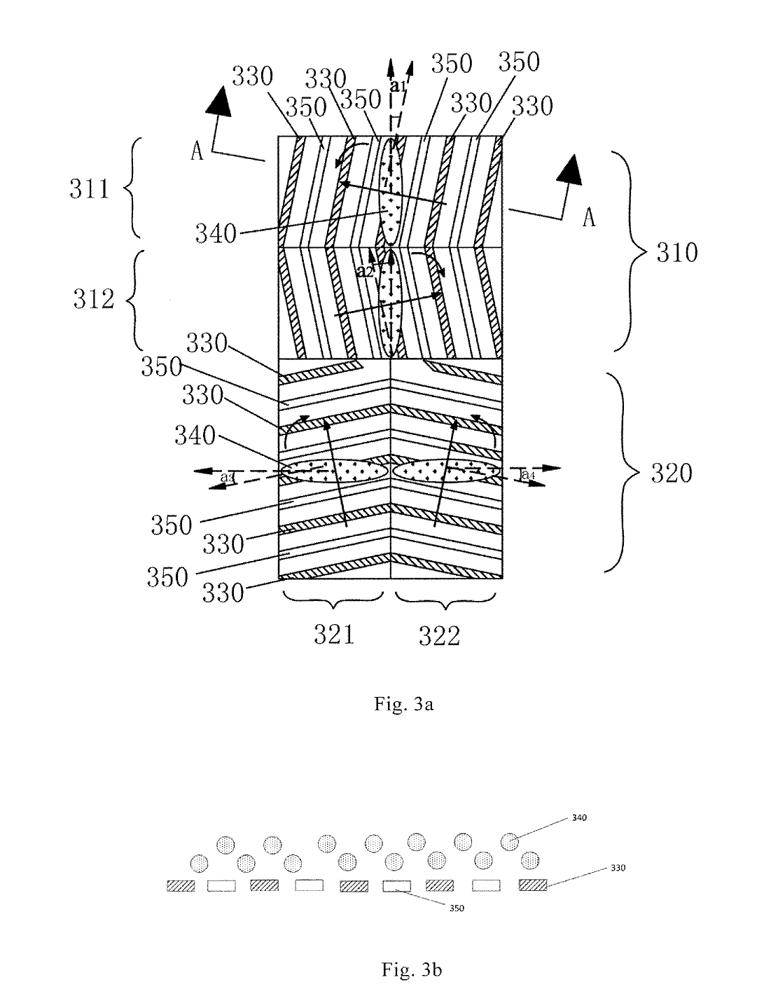

### DETAILED DESCRIPTION

In order to make objects, technical solutions and advantages of the embodiments of the invention apparent, the technical solutions of the embodiment will be described clearly and fully in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention. Hereinafter, various exemplary embodiments are described in detail with reference to the accompanying drawings. Obviously, the following embodiments are used to explain the present invention, and are not intend to limit the present invention.

Embodiments of the present invention provide a liquid crystal panel and a display device. The liquid crystal panel comprises a liquid crystal layer and a pixel region. The pixel region comprises a plurality of pixel units. Each of the pixel units comprises a first subsidiary region and a second subsidiary region.

In an initial state, i.e., the liquid crystal layer is not subjected to action of an electric field, the major axis direction of the liquid crystal molecules in the liquid crystal layer corresponding to the first subsidiary region forms an angle of 90 degrees with respect to the major axis direction of the liquid crystal molecules in the liquid crystal layer corresponding to the second subsidiary region.

For simplicity, positive liquid crystal molecules are described as an example of liquid crystal molecules in the embodiments described below. In addition, all of the angles related to the liquid crystal molecules described in the embodiments of the present invention are obtained when the liquid crystal molecules are in the initial state.

The first subsidiary region comprises at least two subsidiary sub-regions, and the second subsidiary region comprises at least one subsidiary sub-region.

At least two electrodes for applying In-plane electric field to the liquid crystal layer are disposed in the subsidiary sub-regions of first subsidiary region and the second subsidiary region, respectively. The at least one of the two electrodes comprises a strip electrode.

The two subsidiary sub-regions included in the first subsidiary region are a first subsidiary sub-region and a second subsidiary sub-region. The strip electrode(s) of the first subsidiary sub-region forms an angle larger than 0 degree and less than 180 degrees with respect to the strip electrode(s) of the second subsidiary sub-region.

Where a voltage difference is established between the corresponding at least two electrodes of the subsidiary sub-regions of the first and second subsidiary regions, i.e., an In-plane electric field applied to the liquid crystal layer is formed, the liquid crystal molecules in the liquid crystal layer corresponding to the subsidiary sub-regions rotate along the direction of the In-plane electric field under action of the In-plane electric field, so that the problems of poor viewing angle characteristics and severe color shift at different viewing angles of the conventional liquid crystal panel can be alleviated.

### Embodiment 1

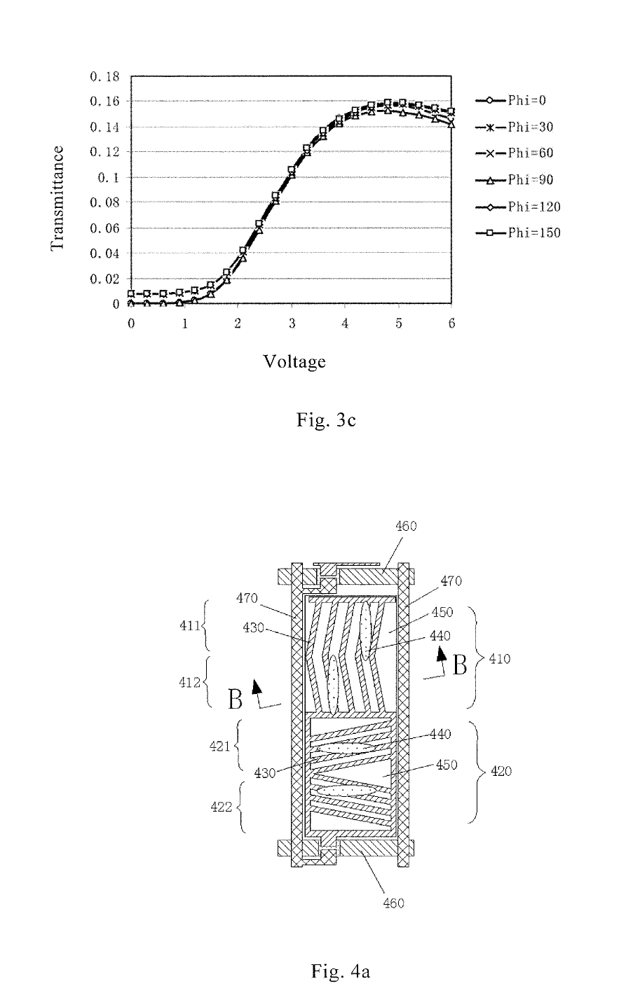

FIG. 3a is a structural schematic view of the electrodes in a pixel unit of a liquid crystal panel according to embodiment 1 of the present invention, and FIG. 3b is a cross-sectional view taken along line A-A of FIG. 3a. The liquid crystal panel in the present embodiment is an IPS panel, and the liquid crystal panel comprises a liquid crystal layer and a pixel region. The pixel region comprises a plurality of pixel units. The electrode structure of each pixel unit is shown in FIG. 3a. Each of the pixel units comprises pixel electrodes 330 and common electrodes 350. Although not shown in FIG. 3a, all of the pixel electrodes 330 are connected with each other, and all of the common electrodes 350 are connected with each other.

The pixel unit comprises a first subsidiary region 310 and a second subsidiary region 320. In the initial state, the major axis direction of the liquid crystal molecules in the liquid crystal layer corresponding to the first subsidiary region 310 forms an angle of 90 degrees with respect to the major axis direction of the liquid crystal molecules in the liquid crystal layer corresponding to the second subsidiary region 320. The first subsidiary region 310 further comprises a first subsidiary sub-region 311 and a second subsidiary sub-region 312. The second subsidiary region 320 further comprises a third subsidiary sub-region 321 and a fourth subsidiary sub-region 322.

At least two electrodes for applying an In-plane electric field to the liquid crystal layer are disposed in the subsidiary sub-regions of the first subsidiary region and the second subsidiary region, respectively. At least one of the two electrodes comprises strip electrodes. For example, in FIG. 3a, each of the first, second, third and fourth subsidiary sub-regions 311, 312, 321 and 322 comprises two electrodes for forming an In-plane electric field, and both of the two electrodes comprise strip electrodes. In the present embodiment, the two electrodes are pixel electrodes 330 and common electrodes 350. Further, the strip electrodes in the same subsidiary sub-region have the same lengthwise direction, and the strip electrodes in different subsidiary sub-regions have different lengthwise directions. For example, the angle between the strip electrodes in the two subsidiary sub-regions of the first subsidiary region is larger than 0 degree and less than 180 degrees, and the angle between the strip electrodes in the two subsidiary sub-regions of the second subsidiary region is larger than 0 degree and less than 180 degrees. The pixel electrodes 330 and the common electrodes 350 are alternatively disposed.

Where no voltage difference occurs between the pixel electrodes 330 and the common electrodes 350, the major axis direction of the liquid crystal molecules 340 of the liquid crystal layer corresponding to the first subsidiary region 310 forms an angle of 90 degrees with respect to the major axis direction of the liquid crystal molecules 340 of the liquid crystal layer corresponding to the second subsidiary region 320. Where a voltage difference is established between the pixel electrodes 330 and the common electrodes 350, an In-plane electric field is formed. The major axis direction of the liquid crystal molecules 340 of the liquid crystal layer corresponding to each of the subsidiary sub-regions rotate toward the direction of the electric field of the subsidiary sub-region (direction of the straight arrow in the figure) along the direction shown by curved arrow in the figure.

In an initial state, the strip electrodes in the first subsidiary sub-region 311 (corresponding to the pixel electrodes 330 and the common electrodes 350 in FIG. 3a) have a first lengthwise direction (direction of the inclined straight dotted line arrow in the first subsidiary sub-region 311 in FIG. 3a). The first lengthwise direction forms a first angle (a1 in FIG. 3a) with respect to the major axis direction of the liquid crystal molecules 340 of the liquid crystal layer corresponding to the first subsidiary sub-region 311. The strip electrodes in the second subsidiary sub-region 312 have a second lengthwise direction (direction of the inclined straight dotted line arrow in the second subsidiary sub-region 312 in FIG. 3a). The second lengthwise direction forms a second angle (a2 in FIG. 3a) with respect to the major axis direction of the liquid crystal molecules 340 of the liquid crystal layer corresponding to the second subsidiary sub-region 312. The strip electrodes in the third subsidiary sub-region 321 have a third lengthwise direction (direction of the inclined straight dotted line arrow in the third subsidiary sub-region 321 in FIG. 3a). The third lengthwise direction forms a third angle (a3 in FIG. 3a) with respect to the major axis direction of the liquid crystal molecules 340 of the liquid crystal layer corresponding to the third subsidiary sub-region 321. The strip electrodes in the fourth subsidiary sub-region 322 have a fourth lengthwise direction (direction of the inclined straight dotted line arrow in the fourth subsidiary sub-region 322 in FIG. 3a). The fourth lengthwise direction forms a fourth angle (a4 in FIG. 3a) with respect to the major axis direction of the liquid crystal molecules 340 of the liquid crystal layer corresponding to the fourth subsidiary sub-region 322.

Further, the first, second, third and fourth lengthwise directions are different from each other, so that they correspond to different subsidiary sub-regions. For example, the first angle a1 is equal to the second angle a2. Further, the third angle a3 is equal to the fourth angle a4.

In one example, the first, second, third and fourth angles are equal to each other.

Further, in the present invention, the first, second, third and fourth angles are in the range between 3 and 30 degrees, for example, between 11 and 20 degrees.

Positive liquid crystal molecules are described as an example of liquid crystal molecules in FIG. 3a. The liquid crystal molecules may be negative liquid crystal molecules as well. Where the liquid crystal molecules are negative liquid crystal molecules, the angles between the minor axis direction of the liquid crystal molecules of the first subsidiary region and the lengthwise directions of the strip electrodes of the two subsidiary sub-regions of the first subsidiary region, and the angles between the minor axis direction of the liquid crystal molecules of the second subsidiary region and the lengthwise directions of the strip electrodes of the two subsidiary sub-regions of the second subsidiary region are in the range between 3 and 35 degrees, for example, between 11 and 20 degrees.

In other example, the first, second, third and fourth subsidiary sub-regions 311, 312, 321 and 322 have equal areas.

FIG. 3c is a graph illustrating transmittance vs. voltage of the liquid crystal panel according to embodiment 1 of the present invention. In FIG. 3c, the polar angle corresponding to the six curves is 60 degrees, the azimuth angle (Phi in the figure) changes between 0 degree and 150 degrees, and the increment step is 30 degrees. That is to say, the curves illustrating transmittance versus voltage (in volts) are obtained by stimulation in the conditions that the transmittance of the liquid crystal panel changes from full black to full white, the polar angle is 60 degrees, and the azimuth angles are 0 degrees, 30 degrees, 60 degrees, 90 degrees, 120 degrees and 150 degrees, respectively. The six curves are obtained as shown in FIG. 3c. It can be seen from FIG. 3c that the six curves of transmission versus voltage corresponding to different viewing angles (different azimuth angles when the polar angles are the same) show better coincidence than the conventional liquid crystal panel, which means that gray scale curves at different viewing angles are close to each other, the transmittance is close to each other, and the anisotropy states of liquid crystal molecules corresponding to different viewing angles are close to each other, so that the problems of poor viewing angle characteristics and severe color shift at different viewing angles of the conventional liquid crystal panel can be alleviated.

### Embodiment 2

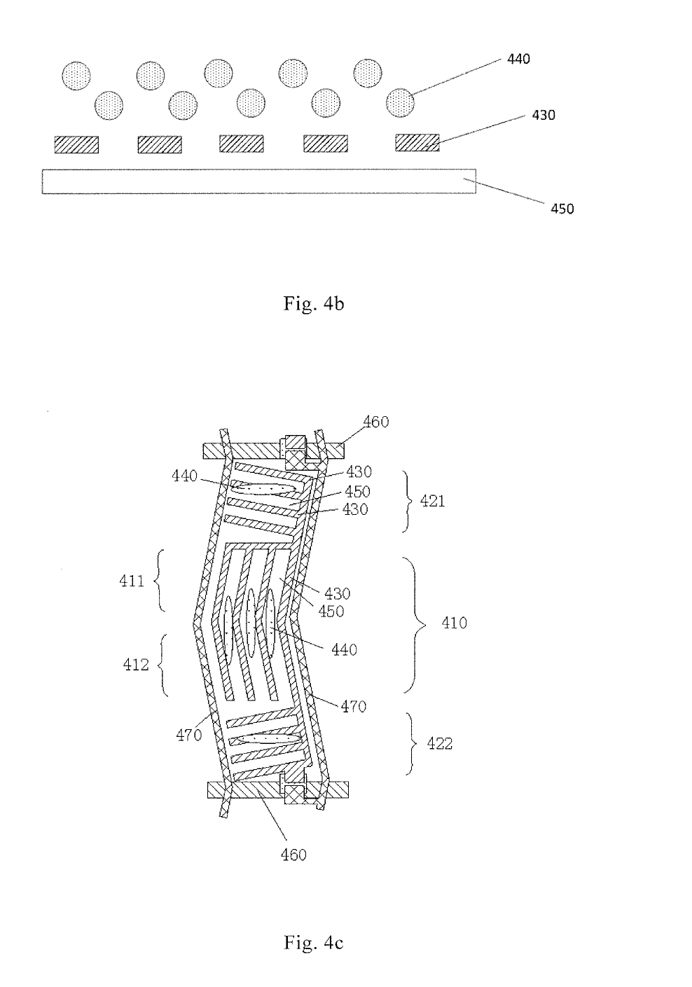

FIG. 4a is a structural schematic view of a pixel unit of a liquid crystal panel according to embodiment 2 of the present invention, and FIG. 4b is a cross-sectional view taken along line B-B of FIG. 4a. The present embodiment is described based on embodiment 1. The liquid crystal panel in the present embodiment is an ADS panel. Referring to FIG. 4b, the ADS panel comprises a liquid crystal layer and a pixel region. The pixel region comprises a plurality of pixel units. Each of the pixel units comprises a pixel electrode 430 and a common electrode 450.

Referring to FIG. 4a, each of the pixel units in the present embodiment comprises a first subsidiary region 410 and a second subsidiary region 420. The first subsidiary region 410 further comprises a first subsidiary sub-region 411 and a second subsidiary sub-region 412. The second subsidiary region 420 further comprises a third subsidiary sub-region 421 and a fourth subsidiary sub-region 422.

Each of the first, second, third and fourth subsidiary sub-regions 411, 412, 421 and 422 comprises at least two electrodes for applying an In-plane electric field to the liquid crystal layer. One of the two electrodes comprises a strip electrode (in embodiment 2, the electrode comprising the strip electrode is a slit electrode in the ADS mode), and the other of the two electrodes is a plate-shaped electrode. More particularly, one of the two electrodes is the common electrode, and the other of the two electrodes is the pixel electrode. In the present embodiment, the common electrode 450 is a plate-shaped electrode, and the pixel electrode 430 comprises a strip electrode. It is note that the common electrode may comprise a strip electrode, and correspondingly the pixel electrode is a plate-shaped electrode.

Where no voltage difference occurs between the pixel electrode 430 and the common electrode 450, the major axis direction of the liquid crystal molecules 440 of the liquid crystal layer corresponding to the first subsidiary region 410 forms an angle of 90 degrees with respect to the major axis direction of the liquid crystal molecules 440 of the liquid crystal layer corresponding to the second subsidiary region 420. Where a voltage difference is established between the pixel electrode 430 and the common electrode 450, an In-plane electric field is formed. The major axis direction of the liquid crystal molecules 440 of the liquid crystal layer corresponding to each of the subsidiary sub-regions rotate along the direction of the electric field of the subsidiary sub-region.

Similar to embodiment 1, in an initial state, the angles between the major axis direction of liquid crystal molecules 440 in the liquid crystal layer corresponding to the first subsidiary region 410 and the strip electrodes of the two subsidiary sub-regions of the first subsidiary region 410 are equal to each other, and the angles between the major axis direction of liquid crystal molecules 440 in the liquid crystal layer corresponding to the second subsidiary region 420 and the strip electrodes of the two subsidiary sub-regions of the second subsidiary region 420 are equal to each other. For example, in the present invention, the angles between the major axis direction of liquid crystal molecules 440 in the liquid crystal layer corresponding to the first subsidiary region 410 and the strip electrodes of the two subsidiary sub-regions of the first subsidiary region 410 are equal to the angles between the major axis direction of liquid crystal molecules 440 in the liquid crystal layer corresponding to the second subsidiary region 420 and the strip electrodes of the two subsidiary sub-regions of the second subsidiary region 420.

In the present embodiment, in an initial state, the angles between the major axis direction of the liquid crystal molecules 440 of the first subsidiary region 410 and the strip electrodes of the two subsidiary sub-regions of the first subsidiary region 410 and the angles between the major axis direction of the liquid crystal molecules 440 of the second subsidiary region 420 and the strip electrodes of the two subsidiary sub-regions of the second subsidiary region 420 are in the range between 3 and 30 degrees, for example, between 5 and 14 degrees.

Positive liquid crystal molecules are described as an example of liquid crystal molecules in FIG. 4a. The liquid crystal molecules may be negative liquid crystal molecules as well. More particularly, where the liquid crystal molecules are negative liquid crystal molecules, the angles between the minor axis direction of the liquid crystal molecules of the first subsidiary region and the strip electrodes of the two subsidiary sub-regions of the first subsidiary region and the angles between the minor axis direction of the liquid crystal molecules of the second subsidiary region and the strip electrodes of the two subsidiary sub-regions of the second subsidiary region are in the range between 3 and 35 degrees, for example, between 5 and 14 degrees.

Meantime, in the present embodiment, the first, second, third and fourth subsidiary sub-regions 411, 412, 421 and 422 have equal areas.

In addition, gate lines 460 and data lines 470 are disposed around the pixel unit as shown in FIG. 4a.

FIG. 4c is a structural schematic view of a modified pixel unit of the liquid crystal panel according to embodiment 2 of the present invention. The structure shown in FIG. 4c differs from the pixel structure shown in FIG. 4a in that the two subsidiary sub-regions of the second subsidiary regions, that is, the third subsidiary sub-region 421 and the fourth subsidiary sub-region 422 are separately disposed each side of the first subsidiary region 410. It is note that FIG. 4c only provides one modified example. The invention does not limit the position relationship among the subsidiary sub-regions included in the pixel unit. For example, the two subsidiary sub-regions of the first subsidiary region 410 may be disposed separately from each other.

In addition, the first and second subsidiary regions of the pixel unit comprise two subsidiary sub-regions in the present invention. It is note that the first subsidiary may comprise two or more sub-regions, and the second subsidiary region may comprise more than one subsidiary sub-region. In this case, more than three orientations of the liquid crystal which are different from each other are formed, thus multi-domain display is achieved, so that the viewing angle characteristics of the liquid crystal panel is improved and the problem of color shift is well solved.

### Embodiment 3

An embodiment of the present invention also provides a display device comprising the liquid crystal panel according to any of the above mentioned embodiments. The display device may be liquid crystal TV, liquid crystal display, notebook computer, tablet, smart phone, etc.

In the liquid crystal panel and display device according to embodiments of the present invention, a pixel unit of the pixel region of the liquid crystal panel comprises a first subsidiary region and a second subsidiary region. In an initial state, the major axis directions of liquid crystal molecules in the two subsidiary regions form an angle of 90 degrees with respect each other. The first subsidiary region comprises two subsidiary sub-regions, and the second subsidiary region comprises one or two subsidiary sub-regions. At least two electrodes for applying an In-plane electric field to the liquid crystal layer are disposed in the subsidiary sub-regions of first subsidiary region and the second subsidiary region, respectively. The at least one of the two electrodes comprises a strip electrode. The strip electrodes of the two subsidiary sub-regions included in the first subsidiary region form an angle larger than 0 degree and less than 180 degrees with respect to each other. When an In-plane electric field is formed by the two electrodes, the major axis direction of the liquid crystal molecules in each of the subsidiary sub-regions rotate toward the direction of the electric field of the subsidiary sub-region, so that the problems of poor viewing angle characteristics and severe color shift at different viewing angles of the conventional liquid crystal panel can be alleviated.

The foregoing is merely the exemplary embodiments of the present invention, and is not intended to limit the present invention. It will note for those skilled in the art that some modifications and substitutions without departing technical principle of the present invention are within the protection scope of the present invention.

1. A liquid crystal panel, comprising a liquid crystal layer and a pixel region, the pixel region comprising a plurality of pixel units, wherein each of the pixel units comprises a first subsidiary region and a second subsidiary region;
in an initial state, a major axis direction of liquid crystal molecules in the liquid crystal layer corresponding to the first subsidiary region forms an angle of 90 degrees with respect to a major axis direction of the liquid crystal molecules in the liquid crystal layer corresponding to the second subsidiary region;
the first subsidiary region comprises at least two subsidiary sub-regions, and the second subsidiary region comprises at least one subsidiary sub-region;
at least two electrodes for applying In-plane electric field to the liquid crystal layer are disposed in the subsidiary sub-regions of the first and second subsidiary regions, respectively, at least one of the two electrodes comprises a strip electrode;
the two subsidiary sub-regions included in the first subsidiary region are a first subsidiary sub-region and a second subsidiary sub-region, and the strip electrode of the first subsidiary sub-region forms an angle larger than 0 degree and less than 180 degrees with respect to the strip electrode of the second subsidiary sub-region.

2. The liquid crystal panel according to claim 1, wherein
in the initial state, the major axis direction of liquid crystal molecules in the liquid crystal layer corresponding to the first subsidiary region forms a first angle with respect to a strip electrode of the first subsidiary sub-region and forms a second angle with respect to a strip electrode of the second subsidiary sub-region, and the first angle is equal to the second angle.

3. The liquid crystal panel according to claim 1, wherein
the second subsidiary region comprises a third subsidiary sub-region and a fourth subsidiary sub-region; and
a strip electrode of the third subsidiary region forms an angle larger than 0 degree and less than 180 degrees with respect to a strip electrode of the fourth subsidiary region.

4. The liquid crystal panel according to claim 3, wherein
in the initial state, a major axis direction of liquid crystal molecules in the liquid crystal layer corresponding to the second subsidiary region forms a third angle with respect to a strip electrode of the third subsidiary sub-region and forms a fourth angle with respect to a strip electrode of the fourth subsidiary sub-region, and the third angle is equal to the fourth angle.

5. The liquid crystal panel according to claim 4, wherein
in the initial state, the major axis direction of liquid crystal molecules in the liquid crystal layer corresponding to the first subsidiary region forms a first angle with respect to the strip electrode of the first subsidiary sub-region and forms a second angle with respect to the strip electrode of the second subsidiary sub-region, the first, second, third and fourth angles are equal to each other.

6. The liquid crystal panel according to claim 3, wherein
the first, second, third and fourth subsidiary sub-regions have equal areas.

7. The liquid crystal panel according to claim 1, wherein:
where the liquid crystal molecules are positive liquid crystal molecules, in the initial state, angles between the major axis direction of the liquid crystal molecules of the liquid crystal layer corresponding to the first subsidiary region and the strip electrodes of the subsidiary sub-regions of the first subsidiary region are in the range between 3 and 30 degrees, and in the initial state, angles between the major axis direction of the liquid crystal molecules of the liquid crystal layer corresponding to the second subsidiary region and the strip electrodes of the subsidiary sub-regions of the second subsidiary region are in the range between 3 and 30 degrees;
where the liquid crystal molecules are negative liquid crystal molecules, in the initial state, the angles between the minor axis direction of the liquid crystal molecules of the liquid crystal layer corresponding to the first subsidiary region and the strip electrodes of the subsidiary sub-regions of the first subsidiary region are in the range between 3 and 35 degrees, and in the initial state, the angles between the minor axis direction of the liquid crystal molecules of the liquid crystal layer corresponding to the second subsidiary region and the strip electrodes of the subsidiary sub-regions of the second subsidiary region are in the range between 3 and 35 degrees.

8. The liquid crystal panel according to claim 7, wherein one of the two electrodes in the sub-regions of the first subsidiary region and the second subsidiary region of the liquid crystal panel comprises a strip electrode, and the other of the two electrodes is plate-shaped electrode,
where the liquid crystal molecules are positive liquid crystal molecules, in the initial state, the angles between the major axis direction of the liquid crystal molecules of the liquid crystal layer corresponding to the first subsidiary region and the strip electrodes of the subsidiary sub-regions of the first subsidiary region are in the range between 5 and 14 degrees, and in the initial state, the angles between the major axis direction of the liquid crystal molecules of the liquid crystal layer corresponding to the second subsidiary region and the strip electrodes of the subsidiary sub-regions of the second subsidiary region are in the range between 5 and 14 degrees;
where the liquid crystal molecules are negative liquid crystal molecules, in the initial state, the angles between the minor axis direction of the liquid crystal molecules of the liquid crystal layer corresponding to the first subsidiary region and the strip electrodes of the subsidiary sub-regions of the first subsidiary region are in the range between 5 and 14 degrees, and in the initial state, the angles between the minor axis direction of the liquid crystal molecules of the liquid crystal layer corresponding to the second-subsidiary region and-the-strip electrodes of the subsidiary sub-regions of the second subsidiary region are in the range between 5 and 14 degrees.

9. The liquid crystal panel according to claim 7, wherein both of the two electrodes in the sub-regions of the first subsidiary region and the second subsidiary region of the liquid crystal panel comprise a strip electrode, and the two electrodes are alternatively disposed;
where the liquid crystal molecules are positive liquid crystal molecules, in the initial state, the angles between the major axis direction of the liquid crystal molecules of the liquid crystal layer corresponding to the first subsidiary region and the strip electrodes of the subsidiary sub-regions of the first subsidiary region are in the range between 11 and 20 degrees, and in the initial state, the angles between the major axis direction of the liquid crystal molecules of the liquid crystal layer corresponding to the second subsidiary region and the strip electrodes of the subsidiary sub-regions of the second subsidiary region are in the range between 11 and 20 degrees;
where the liquid crystal molecules are negative liquid crystal molecules, in the initial state, the angles between the minor axis direction of the liquid crystal molecules of the liquid crystal layer corresponding to the first subsidiary region and the strip electrodes of the subsidiary sub-regions of the first subsidiary region are in the range between 11 and 20 degrees, and in the initial state, the angles between the minor axis direction of the liquid crystal molecules of the liquid crystal layer corresponding to the second subsidiary region and the strip electrodes of the subsidiary sub-regions of the second subsidiary region are in the range between 11 and 20 degrees.

10. A display device comprising the liquid crystal panel according to claim 1.

11. The liquid crystal panel according to claim 4, wherein the first, second, third and fourth subsidiary sub-regions have equal areas.

12. The liquid crystal panel according to claim 5, wherein the first, second, third, and fourth subsidiary sub-regions have equal areas.

13. The liquid crystal panel according to claim 3, wherein:
where the liquid crystal molecules are positive liquid crystal molecules, in the initial state, angles between the major axis direction of the liquid crystal molecules of the liquid crystal layer corresponding to the first subsidiary region and the strip electrodes of the subsidiary sub-regions of the first subsidiary region are in the range between 3 and 30 degrees, and in the initial state, angles between the major axis direction of the liquid crystal molecules of the liquid crystal layer corresponding to the second subsidiary region and the strip electrodes of the subsidiary sub-regions of the second subsidiary region are in the range between 3 and 30 degrees;
where the liquid crystal molecules are negative liquid crystal molecules, in the initial state, the angles between the minor axis direction of the liquid crystal molecules of the liquid crystal layer corresponding to the first subsidiary region and the strip electrodes of the subsidiary sub-regions of the first subsidiary region are in the range between 3 and 35 degrees, and in the initial state, the angles between the minor axis direction of the liquid crystal molecules of the liquid crystal layer corresponding to the second subsidiary region and the strip electrodes of the subsidiary sub-regions of the second subsidiary region are in the range between 3 and 35 degrees.

14. The liquid crystal panel according to claim 13, wherein one of the two electrodes in the sub-regions of the first subsidiary region and the second subsidiary region of the liquid crystal panel comprises a strip electrode, and the other of the two electrodes is plate-shaped electrode,
where the liquid crystal molecules are positive liquid crystal molecules, in the initial state, the angles between the major axis direction of the liquid crystal molecules of the liquid crystal layer corresponding to the first subsidiary region and the strip electrodes of the subsidiary sub-regions of the first subsidiary region are in the range between 5 and 14 degrees, and in the initial state, the angles between the major axis direction of the liquid crystal molecules of the liquid crystal layer corresponding to the second subsidiary region and the strip electrodes of the subsidiary sub-regions of the second subsidiary region are in the range between 5 and 14 degrees;
where the liquid crystal molecules are negative liquid crystal molecules, in the initial state, the angles between the minor axis direction of the liquid crystal molecules of the liquid crystal layer corresponding to the first subsidiary region and the strip electrodes of the subsidiary sub-regions of the first subsidiary region are in the range between 5 and 14 degrees, and in the initial state, the angles between the minor axis direction of the liquid crystal molecules of the liquid crystal layer corresponding to the second subsidiary region and the strip electrodes of the subsidiary sub-regions of the second subsidiary region are in the range between 5 and 14 degrees.

15. The liquid crystal panel according to claim 13, wherein both of the two electrodes in the sub-regions of the first subsidiary region and the second subsidiary region of the liquid crystal panel comprise a strip electrode, and the two electrodes are alternatively disposed;
where the liquid crystal molecules are positive liquid crystal molecules, in the initial state, the angles between the major axis direction of the liquid crystal molecules of the liquid crystal layer corresponding to the first subsidiary region and the strip electrodes of the subsidiary sub-regions of the first subsidiary region are in the range between 11 and 20 degrees, and in the initial state, the angles between the major axis direction of the liquid crystal molecules of the liquid crystal layer corresponding to the second subsidiary region and the strip electrodes of the subsidiary sub-regions of the second subsidiary region are in the range between 11 and 20 degrees;
where the liquid crystal molecules are negative liquid crystal molecules, in the initial state, the angles between the minor axis direction of the liquid crystal molecules of the liquid crystal layer corresponding to the first subsidiary region and the strip electrodes of the subsidiary sub-regions of the first subsidiary region are in the range between 11 and 20 degrees, and in the initial state, the angles between the minor axis direction of the liquid crystal molecules of the liquid crystal layer corresponding to the second subsidiary region and the strip electrodes of the subsidiary sub-regions of the second subsidiary region are in the range between 11 and 20 degrees.
